(19) United States
(12) Patent Application Publication
(10) Pub. No.: US 2016/0335648 A1
(43) Pub. Date: Nov. 17, 2016

(54) SYSTEM AND METHOD FOR MULTIFACETED PUBLISHER MANAGEMENT OF MARKETING ACTIVITIES

(71) Applicant: GroupM Worldwide LLC, New York City, NY (US)

(72) Inventors: Saeed R. Bagheri, New York City, NY (US); Joong Bum Rhim, New York City, NY (US)

(73) Assignee: GROUPM WORLDWIDE LLC, New York City, NY (US)

(21) Appl. No.: 14/709,107

(22) Filed: May 11, 2015

(51) Int. Cl. G06Q 30/02

(52) U.S. Cl. CPC G06Q 30/0204

(57) ABSTRACT

A system and method defining advertiser's objectives and measure performance of various components of a marketing engagement along those objectives to drive actions. One may measure the performance of different audience groups being exposed to the said campaign or may measure the performance of different publishers who participate in the campaign. The measures can be used in audit, evaluation, and investment decision making among others. Input datasets, computes several relevant metrics such as the IF-level population and the latent conversion rate among others are processed for evaluation, and the result are delivered in a designated way. The method further provides various outputs on demand, and it may provide a conversion-fountain graph separating conversions due to random audience behaviors and due to impact of advertising. It provides an I² plane that categorizes publishers or audience groups among others and suggests future marketing decision with respect to their past conversion performance.

### BACKGROUND

Availabilities of computer networks, such as the Internet, have expanded the horizons of targeted advertisements. With these computer networks, advertising are omnipresent to users, whether they are visibly apparent to the users. At the same time, user activities and experiences on computing platforms other than traditional desktops or workstations, such as smartphones, tablets, head-mounted displays, etc., are richer. As such, advertising on these additional platforms further encourage developments in this area for more than just an entrepreneurial innovation but a technological one.

For example, some prior art describes a scoring algorithm of blogs to improve target advertisements. It estimates targeting performance based on blog content and how it matches keywords. This prior art focuses specifically on comparing blogs and contents.

In another example, prior technologies attempt to teach a method and system that analyzes performance of keywords based on conversion rate associated with the keywords. This prior also focuses on the area of keyword performance. Another system of the prior art analyzes and scores creative content in order to choose a better creative content to deliver. Many further prior art disclose a method to predict the click-through rates metric of online display ads within a given site.

Unfortunately, rather than reactive, it would be preferable to be proactive in targeted advertising by measuring publisher performance and decision making on future investment in different publishers that is based on audience profile of publishers and the publisher's ability to drive behavioral change in audience.

### SUMMARY

Aspects of the invention differ from prior technology by measuring audience quality of sites as well as their conversion causality and making the decision about future investment. Moreover, based on determining publisher performance, embodiments of the invention facilitate decision making on future investment in different publishers. Moreover, unlike prior technologies that quantify advertising performance, embodiments of the invention use or employ campaign execution data and evaluate performance at a publisher-level.

### BRIEF DESCRIPTION OF DRAWINGS

FIG. 1 is a screenshot of a result of a search term using a search engine on the Internet.

FIG. 2A is a graph showing three publishers participate in a campaign and their overall reach according to one embodiment of the invention.

FIG. 2B shows a graph illustrating the reach of the individual publishers according to one embodiment of the invention.

FIGS. 3A and 3B illustrate exemplary graphs showing conversions, especially sales, due to the impressions according to one embodiment of the invention.

FIGS. 4A and 4B illustrate exemplary graphs showing conversions, especially, sales, due to the impressions in terms of the interval from the last impression to the conversion according to one embodiment of the invention.

FIG. 5 illustrates an exemplary graph showing an example of n(p) and i(p) according to one embodiment of the invention.

FIG. 6 illustrates an exemplary tree structure showing a daily movement of audiences according to one embodiment of the invention.

FIG. 7 illustrates an exemplary tree structure showing a movement of audiences from no impression to conversion at B_{5,1} according to one embodiment of the invention.

FIG. 8 illustrates an exemplary state transition with respect to the last impression and a conversion according to one embodiment of the invention.

FIG. 9 illustrates an exemplary graph of an average latent conversion rate according to one embodiment of the invention.

FIG. 10 illustrates an exemplary conversion-fountain graph depicting the classification of conversion of Publisher E according to one embodiment of the invention.

FIG. 11 illustrates an exemplary graph showing Inherent-influential (I²) plane according to one embodiment of the invention.

FIGS. 12A and 12 B illustrate exemplary three dimensional diagrams showing Inherent-influential and cost (I²C) space according to one embodiment of the invention.

FIG. 13 illustrates an exemplary system for determining effectiveness of a publisher according to one embodiment of the invention.

FIG. 14 illustrates an exemplary graphical user interface for receiving input from a user for determining the efficiency of a publisher according to one embodiment of the invention.

FIG. 15 illustrates an exemplary input graphical user interface according to one embodiment of the invention.

FIG. 16 illustrates one of an output graphical user interface according to one embodiment of the invention.

### DETAILED DESCRIPTION

Embodiments of the invention transform campaign execution data and evaluate performance at a publisher-level. For example, online display campaigns are frequently ordered by advertisers and executed by publishers. There are several measures of the performance, such as cost per mille (CPM) and cost per impression (CPI). However, the idea under the measures are similar: Attract more customers, and you will get paid more. In another example, the term “conversion” is generally used in advertisement to refer to customers' actions that reveal their interest in or attention to the advertised product. It includes various actions, which does not have to be a purchase. Some examples include to read product descriptions, to customize a product, and to send a quote. Other actions may be available depending on the campaign. For simplicity and for exemplary illustration purposes only, however, a conversion means only sales in discussing some aspects of the invention.

Advertisers and publishers seem like a team in the sense that increasing the number of conversion is beneficial to both; it will increase the revenue of advertisers and the reward of publishers. In order to increase a conversion rate, publishers use several targeting techniques, such as behavioral targeting and lookalike targeting. The purpose of targeting is to understand each individual's interests and to show personalized display ads that are most relevant to the individual. Demographic information, such as gender, age, annual income, and address, etc., that statistically implies individual's general interests and web browsing history data that reveal individuals' specific interests are widely used.

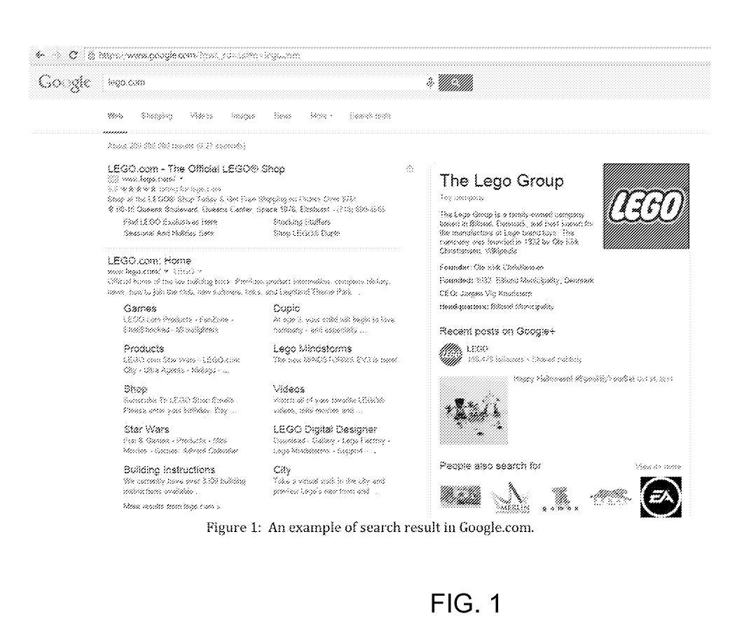

Moreover, behavioral targeting has been a new trend of online advertising. It is believed that the behavioral targeting benefits advertisers because it does not waste impressions (and thus advertising budget of advertisers) to individuals who are not interested in the companies or the products. For example, a luxury car maker would not want to advertise their cars to people who cannot afford it. Moreover, there are various ways to provide or present such targeted advertising. For example, FIG. 1 illustrates one simple example of a targeted advertising based on a result of a search term “lego.com”.

However, true value of a conversion is different to advertisers and to publishers. While advertisers concern the number of entire customers through all possible channels, publishers only concern the number of customers who use their own channels. Publishers can make easy money by sending impressions to customers who will purchase the advertisers' products anyway (probably via a different channel if they do not see the impressions). On the other hand, this kind of advertising does not increase the number of total customers for advertisers. It only costs them extra. For example, FIG. 1 illustrates a screenshot of a search result from Google.com with a search term “lego.com.” This search term shows that this user's intention to enter the website of Lego regardless of an advertisement. In this example, Google.com would be considered as a publisher while Lego would be considered as an advertiser. However, Google.com still shows the advertisement of Lego in the first line to induce a click by the user and takes advantage of it. This is an example of targeting that advertisers would not benefit from. Thus, often advertisers would want the impression to be delivered randomly to increase the chance of making new customers.

It is to be understood that proper targeting is important for successful campaigns. The problem is that advertisers do not know what algorithms publishers use to select the targets. They do not know whether the algorithms select potential customers or just bring those who are about to complete their purchase. According to one embodiment, the former is called effective publishers and the latter is called ineffective publishers. Even though to ask which publisher is effective is an important question, it is difficult to answer this question. Moreover, there is no prior work that tries to differentiate such value of sales and aspects of the invention focus on whether a strategy of publishers is beneficial to advertisers.

Embodiments of the invention propose a method to measure effectiveness of publishers by analyzing the campaign results. Aspects of the invention analyze baseline conversion probabilities of customers selected by each publisher. By definition, ineffective publishers select customers who are highly likely to convert. Consequently, the average baseline conversion probability of the population selected by ineffective publishers must be higher than that of the population selected by effective publishers. Embodiments of the invention aim to first estimate the average baseline conversion for each publisher in each campaign and to compare it with a proper threshold of effectiveness. Both accurate estimation of the advertising effect and proper determination of the threshold are important in this method. The first half of this investment delivers intuitions of determining the threshold and the next half will discuss estimating the performance.

In one embodiment, section 2 describes the data set used for one implementation of embodiments of this invention. Section 3 clarifies the problem—measuring publisher's effectiveness—and strictly defines effective and ineffective publishers. Section 4 provides one embodiment for developing the invention methodology and the computation of statistics of impression delivery and conversion. Section 5 explains how campaign performances are estimated; the results are discussed in Section 6. Section 7 concludes this investment.

Section 2

In one embodiment and as an example, data obtained from a plurality of campaigns of an advertiser that took place within a plurality of dates. The data has been gathered in detail. Some of the attributes used in this analysis are: date, the number of impressions delivered on each day, the number of conversions on each day, conversion (activity) type, and intervals from impressions to conversions.

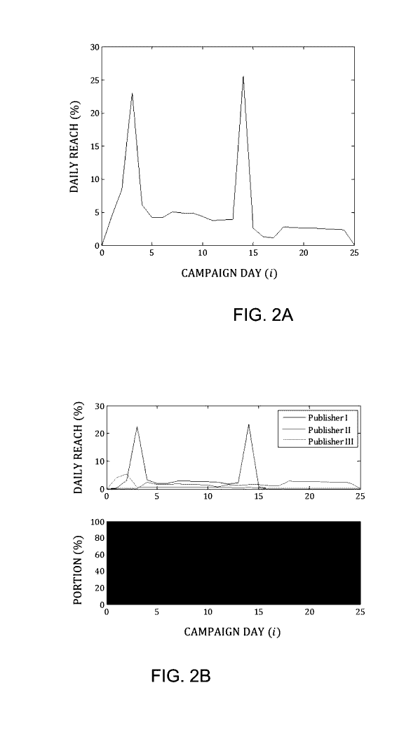

FIG. 2 shows reach of an example campaign. The reach is defined as the ratio of the number of unique people exposed to impressions on each day to the target population N. Three publishers participate in this campaign and their overall reach is shown in FIG. 2a. FIG. 2b shows the reach of the individual publishers. While Publisher I delivers most impressions on two days, Days 3 and 14, Publisher III delivers impressions quite uniformly for a longer term, Days 4-24.

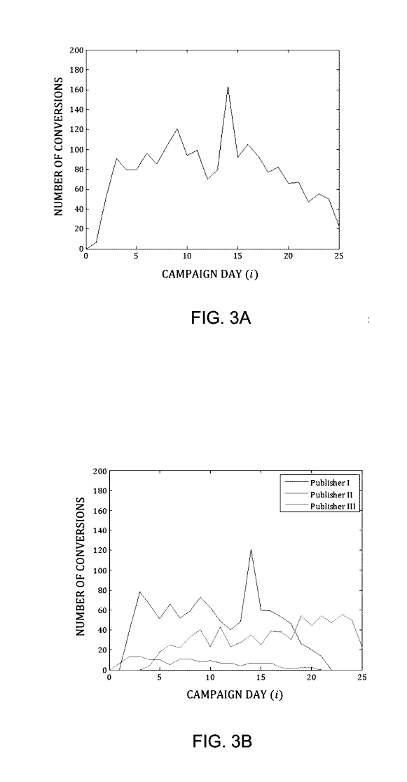

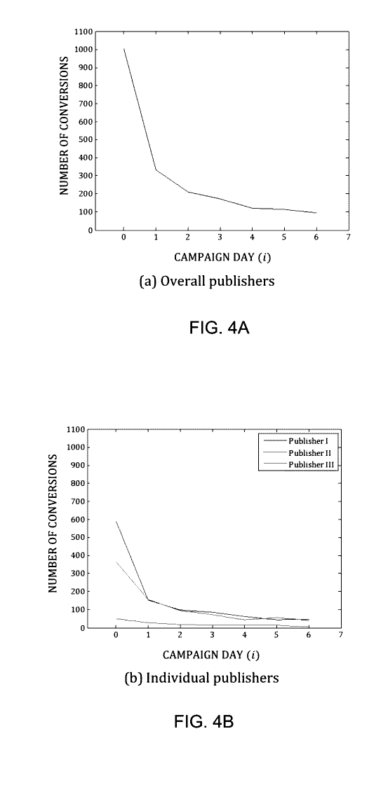

The corresponding conversion results are shown in FIGS. 3A and 3B. FIGS. 3A and 3B illustrate an example of conversions, especially sales, due to the impressions. FIG. 3A illustrates a graph showing overall publishers, and FIG. 3B illustrates individual publishers (3). The conversions are displayed in terms of campaign day i. If the conversion results are displayed in terms of the time interval between last impression and conversion, as in FIGS. 4A and 4B, a pattern emerges: The number of conversions due to impressions decreases over time. It is a common phenomenon of advertising that the effect of ads decays as time passes on because people forget about them. For example, FIGS. 4A and 4B illustrate an example of conversions, especially sales, due to the impressions in terms of the interval from the last impression to the conversion. FIG. 4A illustrates a graph showing overall publishers, and FIG. 4B illustrate individual publishers (3).

3 Problem Description

3.1 Advertisement Model

An advertiser wants to figure out which publisher is effective and which is ineffective after an L-day-long online display campaign executed by Publishers 1, 2, . . . , K. Thus the goal is to determine a factor xₖ that evaluates the effectiveness of Publisher k and a corresponding threshold x* to classify the publishers; Publisher k is suspected to be ineffective if xₖ<x*.

Let N be the population of all potential targets of the advertising. On Day i, publishers autonomously deliver impressions to nᵢ unique people. The ratio rᵢ [symbol] nᵢ/N is called reach according to one embodiment of the invention. In one embodiment, this determination or ratio may further be referred to a segmentation logic.

Without the advertising campaign, people convert with probability of p_{B} on average. This probability is called a baseline conversion rate. Upon getting an impression, people would be converted with a higher probability. Let α denote the increase of the conversion rate due to the campaign, αε[0,1]. An audience who receives an impression on Day i may convert with probability of p_{B}+α on the same day. The probability would depend on the type of the campaign and the creative used in the campaign.

Even if the audience does not convert on Day i, the audience may convert a few days later as long as the impact of the impression lasts. In one embodiment, the impact decays over time and let γ denote the decay factor per day, γε[0,1]. The audience converts with probability of p_{B}+αγ the next day when she is in Impression Fadeaway level (IF-level) 1. The conversion rate is p_{B}+αγ^{j} after j days when she is in IF-level j. According to one embodiment of the invention, the effect of the advertising and measure publishers' effectiveness are estimated.

Note that the baseline conversion rate is equal to p_{B} if the impressions are completely randomly delivered. In one example, the value of p_{B} can be obtained based on marketing intuitions and characteristics of the advertiser and its vertical. For example, the advertiser's market share, average replace period of its products, and the percentage of online sales determine p_{B}. In practice, however, publishers may target people with specific features with respect to their demographic information or online activities in order to achieve a higher conversion rate. Distinguishing from the baseline conversion rate of general audiences p_{B}, the baseline conversion rate of the targeted audiences is denoted as q_{B} according to one embodiment of the invention. Ultimately, the conversion rate of a publisher is modeled as q_{B}+αγ^{j}.

In order to reveal the decay factor, it is important to consider when an audience experienced his or her last impression. Let B_{i,j} denote the set of audiences in IF-level j, measured on Day i. They convert on Day i with probability of q_{B}+αγ^{j}; the number of conversions is denoted by N_{i,j}. With rᵢ and N_{i,j} given, the expected value of B_{i,j} is calculated and q_{B}, α, γ is estimated. One embodiment of the computation is explained in Sections 4 and 5.

3.2 Meaning of Effective Publishers

For the purpose of evaluation, “effectiveness” needs to be strictly defined as a function of advertising key performance indicators (KPI), e.g., short-term sales, long-term sales, and brand awareness. This effectiveness can have several definitions depending on advertiser's desire. In one embodiment of the invention, two ingredients for measuring effectiveness are provided. A person skilled in the art can appropriately define effectiveness starting from the embodiments below for several cases.

### 3.2.1 Embodiment 1

### Maximum Net Increase of Conversions (Max-Conversion Model)

In this embodiment, a metric about the increase of conversions purely due to advertisement is presented. For a conversion probability pε[0, 1], the number of people whose conversion probability is within [p,p+dp) is counted before being exposed to an impression, where dp<<1. Let n(p) denote the number; in one embodiment, it is called a preference function. Thus, n: [0,1] [symbol] {0}∪ [symbol] ⁺ describes a distribution of people in terms of their conversion probability. Note that n(p) is not normalized;

∫₀¹n(p)dp=N.

For a specific p, p×n(p) people are converted on average without an impression. The baseline conversion rate of all population is given by

$${p}_{B} = \frac{1}{N} {\int }_{0}^{1} pn ( p ) d p . \qquad ( 1 )$$

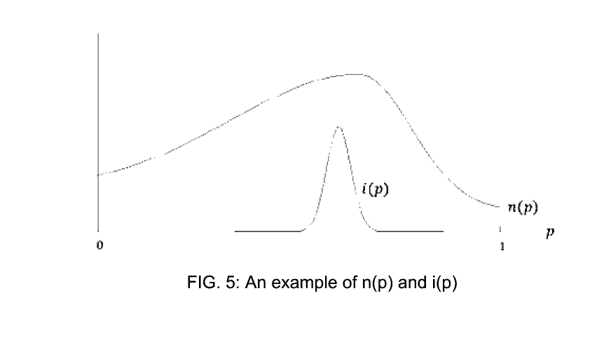

After a publisher executes a campaign, the number of people who receive impressions from the publisher are counted according to one embodiment of the invention. Let i(p) denote the number of such people whose conversion probability is within [p, p+dp) for pε[0,1]. Again, i: [0,1] [symbol] {0}∪ [symbol] ⁺ is an unnormalized distribution of the targeted people in terms of their conversion probability. It is called a delivery function according to one embodiment of the invention. An example of n(p) and i(p) is depicted in FIG. 5.

The delivery function i(p) determines the performance of the campaign. Suppose that the campaign has an effect of changing the conversion likelihood from p to g(p), where g: [0,1] [symbol] [0,1]. g(p) is called an effect function according to one embodiment of the invention. Among the people whose conversion probability is initially p, those who see impressions will convert with probability of g(p) and the others with p. The expected number of conversions after the campaign is

∫₀¹g(p)i(p)dp+∫₀¹p[n(p)−i(p)]dp=∫₀¹pn(p)dp+∫₀¹[g−p]i(p)dp (2)

Since ∫₀¹ p n(p)dp is the expected number of people who would convert regardless of the campaign, the baseline conversion probability is given by p_{B}=∫₀¹ p n(p)dp/N. The campaign increases the number of conversions by ∫₀¹[g(p)−p]i(p)dp. Without loss of generality, it is assumed that g(p)≧p, ∃pε[0, 1]. It implies that the campaign does not have a negative effect. Also, g(p) is assumed to be monotonically increasing in p. It means that, for any p₁>p₂, a person with p₁ always has a higher conversion probability than a person with p₂ when they both receive impressions. The best-performing (or perfect) publisher would deliver impressions to the population of i*(p), which satisfies

i*(p)=argmaxᵢ₍ₚ₎∫₀¹[g(p)−p]i(p)dp. (3)

Then the baseline conversion rate of the ideal target i*(p) is given by

q_{B}*=∫₀¹p i*(p)dp. (4)

According to one embodiment, q_{B}* is called ideal baseline conversion rate. By comparing the baseline conversion rate of actual audiences, \hat{q}_{B}, to the ideal baseline conversion rate, one may measure how close the actual targeting is to the ideal targeting according to one embodiment of the invention.

### 3.2.2 Embodiment 2

### Inconsistent Targeting (Performance Stability Model)

Consider a publisher that executes multiple campaigns of an advertiser. If the publisher understands the market of the advertiser, it would perform consistently well in terms of the conversion rate. On the other hand, if the conversion rate widely varies from campaign to campaign, in one embodiment, the publisher does not understand the market and poorly executes the campaigns. In this case, publishers with consistent performances can be considered as effective and publishers with inconsistent performances as ineffective. As such, this performance stability model may provide an indication, a factor, or a function to determination of an effectiveness of a publisher according to one embodiment of the invention.

Strictly speaking, let us assume that a publisher delivers impressions to M audiences according to the delivery function i(p) in FIG. 5. The baseline conversion rate of the audience group can be expressed by an indicator variable Iₘ:

$${q}_{B} = \frac{{I}_{1} + {I}_{2} + … + {I}_{M}}{M} , \qquad ( 5 )$$

Where

$${I}_{m} {=}^{Δ} \{ \begin{matrix}1 , & if the mth audience converts regardless \\ 0 , & otherwise\end{matrix} \qquad ( 6 )$$

If the mth audience's baseline conversion rate is pₘ, then Iₘ is a Bernoulli random variable whose value is 1 with probability of pₘ and 0 with probability of 1−pₘ.

The variance of q_{B} is

$$Var ( {q}_{B} ) = \frac{Var ( {I}_{1} + {I}_{2} + … + {I}_{M} )}{{M}^{2}} = \frac{{\sum }_{m = 1}^{M} Var ( {I}_{m} )}{{M}^{2}} = \frac{{\sum }_{m = 1}^{M} {p}_{m} ( 1 - {p}_{m} )}{{M}^{2}} , \qquad ( 6 )$$

which is also called conversion rate volatility. A threshold is determined depending on objectives of an advertiser according to one embodiment of the invention.

Besides the consistency of performance, however, preference of the advertiser should be taken into account to the judgment of goodness as another factor to determine the effectiveness of a publisher. An adventurous advertiser may value publishers with inconsistent performances especially if the inconsistency is caused by trying different targeting strategies and different sets of audiences.

4 Impression Delivery Statistics

Statistical analysis is employed on the population in IF-level j to measure short-term and long-term impact of advertisement according to one embodiment of the invention. This section explains how to compute these statistics for given reach data rᵢ, i=1, 2, . . . , L. Two embodiments are illustrated for the computation but other different computational methods are possible within aspects of the invention. A person skilled in the art may be able to come up with a different method starting from embodiments of the invention.

4.1 IF-Level Population Model

4.1.1 Random Delivery

This section explains how to compute IF-level population B_{i,j} and cumulative IF-level population A_{i,j}. Let [symbol] denote the set of all target population of the campaign, where | [symbol] |=N. In one embodiment, the set of audiences in IF-level j on Day i is [symbol] _{i,j}. Its cardinality, | [symbol] _{i,j}|=B_{i,j}, is the population of IF-level j on Day i. In addition, let [symbol] _{i,φ} denote the set of people who have never gotten an impression until Day i for i≧0, i.e.,

[symbol]

_{i,φ}= [symbol] −( [symbol] _{1,0}∪ [symbol] _{2,0}∪ . . . ∪ [symbol] _{i,0}).

Before the campaign begins, all audiences are in [symbol] _{0,φ}, i.e., [symbol] _{0,φ}= [symbol] . On the first day of the campaign, audiences are randomly chosen to see an impression with probability r₁. These selected audiences will belong to [symbol] _{1,0}, and the others will belong to [symbol] _{1,φ}. The expected cardinality of the sets are [symbol] [ [symbol] _{1,0}]=r₁ N and [symbol] [ [symbol] _{1,φ}]=(1−r₁) N. On Day 2, audiences are randomly chosen again with probability r₂ regardless of their states on Day 1. Thus, the expected number of people who receive an impression on Day 2 is [symbol] [ [symbol] _{2,0}]=r₂ N. Among them, on average r₁ r₂ N audiences come from [symbol] _{1,0} and the rest of [symbol] _{1,0} will belong to [symbol] _{2,1}. Likewise, (1−r₁) r₂ N audiences come from [symbol] _{1,φ} to [symbol] _{2,0} and the rest of [symbol] _{1,φ} will belong to [symbol] _{2,φ}.

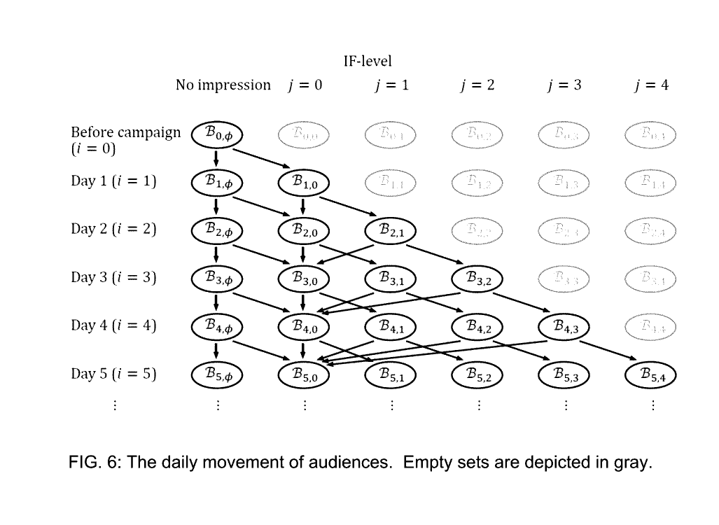

FIG. 6 depicts how [symbol] _{i,j} is constructed on each day of the campaign. An arrow from a set [symbol] _{i,j} to another set [symbol] _{i+1,j}′ indicates that audiences in [symbol] _{i,j} on Day i can belong to [symbol] _{i+1,j}′ the next day, i.e., [symbol] _{i,j}∩ [symbol] _{i+1,j′}#φ. If there is no arrow between them, [symbol] _{i,j}∠ [symbol] _{i+1,j′}=φ. In one embodiment, the expected cardinality is computed as [symbol] _{i,j} [symbol] [ [symbol] _{i,j}].

In addition, for example, one may compute the number of cumulative audiences who have ever been in IF-level j at least once throughout the campaign. Let [symbol] _{i,j} denote the set of such audiences from Day 1 to Day i and A_{i,j} [symbol] | [symbol] _{i,j}|:

[symbol]

_{i,j} [symbol] [symbol] _{1,j}∪ [symbol] _{2,j}∪ . . . ∪ [symbol] _{i,j}. (7)

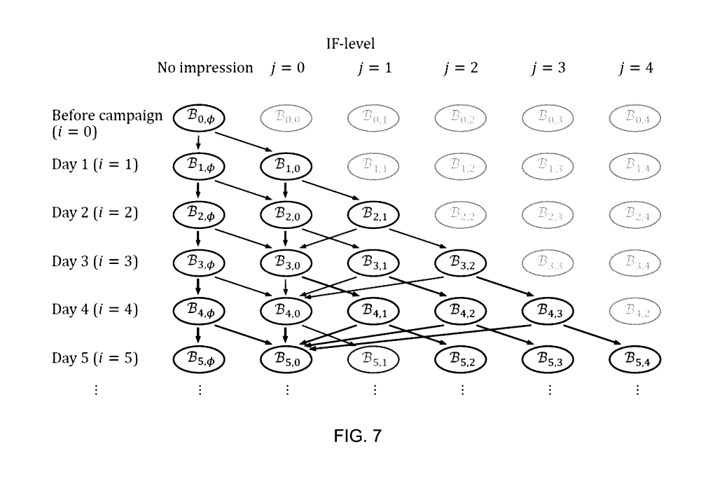

It is not simple because the sets [symbol] _{i,j} and [symbol] _{i′,j} are not either disjoint nor statistically independent for i#i′. For example, FIG. 7 illustrates a diagram showing the movement of audiences from B o,φ to B 5,1. In this figure, relevant arrows are drawn in red and feasible states before arriving at B 5,1 are drawn in blue. Note that audiences can belong to B 5,1 regardless of their states until Day 3, but their states on Day 4 matters in this example. For example, FIG. 7 highlights all paths (potentially) towards [symbol] _{5,1}. It shows that people in [symbol] _{2,1} or [symbol] _{3,1} may be in [symbol] _{5,1} but people in [symbol] _{4,1} cannot. Generally speaking, for j≧1, the state before Day i-j is irrelevant to whether a person can be in the set [symbol] _{i,j} or not. However, the state on or after Day i-j is critical to get to the set [symbol] _{i,j}; only people in the set [symbol] _{i-j+l,l} can be in the set [symbol] _{i,j} for l=0, 1, . . . , j.

In one embodiment, these two important observations are summarized as follows: First, [symbol] _{i,j}⊂ [symbol] _{i-j,0}. The probability of an audience in [symbol] _{i-j,0}, will belong to [symbol] _{i,j} is Πₗ₌ᵢ₋ⱼ₊₁ⁱ(1−rₗ). Second, [symbol] ᵢ₋ⱼ₊ₗ∩ [symbol] _{i,j}=φ for l=0, 1, . . . , j.

These observations lead to the following result:

[symbol]

_{i-1,j}∩ [symbol] _{i,j}= [symbol] _{i-j-1,j}∩ [symbol] _{i,j}={Audiences who are in IF-level j on Day i-j-1 and receive an impression, which is their last one, on Day i-j}, (8)

which yields

[symbol]

[| [symbol] _{i-1,j}∩ [symbol] _{i,j}|]= [symbol] [A_{i-j-1,j}]rᵢ₋ⱼΠₗ₌ᵢ₋ⱼ₊₁ⁱ(1−rₗ). (9)

The expected cardinality of [symbol] _{i,j} is derived in a recurrence relation form.

4.1.2 Targeting Exposed Population

A publisher may deliver impressions again to people who have already seen ones especially when the people seem to be converted sooner or later. One example is retargeting: A publisher repeatedly shows impressions to customers with abandoned shopping carts until they check them out. If the publisher delivers impressions again, it may change the probability of receiving impressions for the people in [symbol] _{i,j}.

Let us assume that the publisher targets exposed population with a factor of tᵢ on Day i. It means that tᵢ Σⱼ₌₀ⁱ⁻²B_{i-1,j} people are targeted on that day. In one embodiment, among N rᵢ impressions to be delivered, tᵢ Σⱼ₌₀ⁱ⁻² [symbol] _{i-1,j} impressions are delivered randomly to people who have seen the impressions before. The remaining N rᵢ−tᵢ Σⱼ₌₀ⁱ⁻²B_{i-1,j} impressions are distributed randomly to the others; its delivery probability is

$${r}_{i}^{′} = \frac{N {r}_{i} - {t}_{i} {\sum }_{j = 0}^{i - 2} {B}_{i - 1 , j}}{N - {t}_{i} {\sum }_{j = 0}^{i - 2} {B}_{i - 1 , j}} . \qquad ( 10 )$$

In one embodiment, the targeting factor may be defined as

$${t}_{i} = min \{ \overline{t} , \frac{N {r}_{i}}{{\sum }_{j = 0}^{i - 2} {B}_{i - 1 , j}} \} , \qquad ( 11 )$$

where t̅ is an upper limit of targeting factor that is internally determined by the publisher. This definition (11) prevents rᵢ′ from being negative-valued.

For a group [symbol] _{i-1,j}, tᵢ portion of people will be targeted and rᵢ′ portion of the rest of people will be randomly chosen as audiences. In other words, tᵢ+(1−tᵢ) rᵢ′ portion of people will see impressions and become in [symbol] _{i,0}. For a group [symbol] _{i-1,φ}, only rᵢ′ portion of people will be newly see impressions and become in [symbol] _{i,0}. The computation of [symbol] [B_{i,j}] is the same as that in Section 4.1.1 except that the reach rᵢ is replaced by these new probabilities of seeing impressions. Compared to B_{i,j} without targeting in Section 4.4.1, B_{i,j} with targeting is smaller for j≧1 because people who have seen an impression are more likely to receive another impression than are those who have not.

4.2 Latent Converting Power Model

The embodiment in Section 4.1 deals with a whole population and separate them into groups according to their states with respect to IF-level. This section presents another embodiment to understand transitions of the state at an individual-level. The model leads to estimation of latent converting power of an impression or, more specifically speaking, the conversion probability of audiences in IF-level j. Let qⱼ denote the latent conversion rate in IF-level j. According to Section 3, this is modeled as qⱼ=q_{B}+αγ^{j} for j≧0. Audiences are assumed not to convert more than once and not to be exposed to an impression once they are converted. This is a reasonable assumption for modeling sales-type conversions. Individual audiences are in one of the following states, depending on when they receive an impression and on whether they are converted: [symbol] ⱼ, the states of remaining unconverted in IF-level j, and [symbol] ⱼ, the states of having converted in IF-level j, for j≧0. Specially [symbol] _{φ} indicates the state in which audiences have not seen any impression and not converted, and [symbol] _{φ} indicates the state in which audiences have converted without an impression.

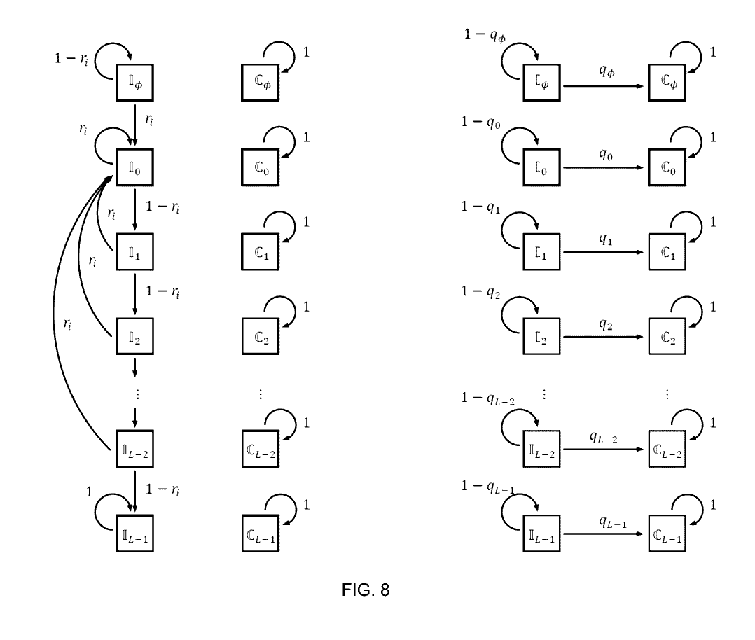

FIG. 8 depicts state-transition diagrams. For example, FIG. 8 is a description of state transition with respect to the last impression and a conversion. As depicted, squares indicate states of an individual and values next to (or above arrows are transition probabilities between two states. For convenience and illustrative purposes only, actions that occurred in one day are separated into two phases: impression and conversion phases. At the beginning of Day i, an audience is in state [symbol] ⱼ. In the first, impression phase, the audience gets an impression with probability rᵢ. If she gets an impression, her state becomes [symbol] ₀; otherwise, her state moves to [symbol] ⱼ₊₁ for j≧0. According to the algorithm, an audience who was in [symbol] _{L} on Day i−1 should move to [symbol] _{L+1} on Day i if the audience does not get an impression with probability of rᵢ. However, since the campaign is L days long, practically no one is in [symbol] _{L} until Day L−1; the first time when someone—who have received an impression on Day 1 and none afterwards, and are not converted—is in [symbol] _{L} is Day L. No state transition practically occurs from [symbol] _{L} because the campaign is over. Hence, it does not matter how transitions from [symbol] _{L} are defined. For computational simplicity, it is simply assumed that anyone who gets in [symbol] _{L} will stay there. There is no transition from [symbol] ₖ to [symbol] ⱼ because once converted, the audience remains in her state for the rest of the campaign. In the second, conversion phase, the audiences in state [symbol] ⱼ converts (and move to state [symbol] ᵢ) with probability qⱼ. After simulating these transitions for L days, the probability of an audience being in each of the states is obtained according to one embodiment of the invention. Then, how many people convert in IF-level j by multiplying its probability by total population N may be determined.

Note that [symbol] ⱼ are transient states but [symbol] ⱼ are absorbing (steady) states. Thus, people are accumulated in the states [symbol] ⱼ throughout the campaign. The number of people in state [symbol] ⱼ on Day i is the same as Σₖ₌₁ⁱN_{k,j}. This model is useful to estimate the number of conversions during a campaign.

The distribution after Day i is described as a vector πᵢ of length (2L+2), whose entries respectively correspond to the states { [symbol] _{φ}, [symbol] ₀, [symbol] ₁, . . . [symbol] _{L-1}, [symbol] _{φ}, [symbol] ₀, [symbol] ₁, . . . [symbol] _{L-1}} according to one embodiment of the invention. Also, the state transition diagrams in FIG. 8 can be described by (2L+2)-by-(2L+2) state transition matrices Tᵢ [symbol] and Tᵢ [symbol] , respectively. A daily transition matrix T_{i-1,i} is the multiplication of these two matrices:

T_{i-1,i}=Tᵢ [symbol] ×Tᵢ

[symbol]

The initial distribution is π₀=[1 0 0 . . . 0]; the audience is certainly in state [symbol] _{φ} is 1 before the campaign. Her distribution after Day 1 is π₁=π₀ T_{0,1}=π₀T₁ [symbol] T₁ [symbol] . More generally, the distribution after Day i is given by πᵢ=π₀ Πₗ₌₁ⁱT_{l-1,l}; its (L+j+3)-th entry, which is denoted by πᵢ[L+j+3], corresponds to the probability of state [symbol] ⱼ after Day i. Let M_{i,j} denote the number of conversions in IF-level j, i.e., the number of conversions among people in B_{i,j}. Then the number of people in state [symbol] ⱼ on Day i, πᵢ[L+j+3]×N, is equal to Σₗ₌₁ⁱ=M_{i,j}.

5 Estimating the Advertising Effect

As discussed, the effect of campaign on increasing the conversion rate is modeled as an exponential decay function, qⱼ=q_{B}+αγ^{j}, where q_{B} denotes the baseline conversion rate (of the behaviorally targeted audiences), α denotes increase of conversion rates due to the advertising, and γ denotes daily decay factor of the effect. Estimates of these parameters—\hat{q}_{B}, \hat{α}, and \hat{γ}, are computed respectively—for each publisher's each campaign. Then the baseline conversion rates \hat{q}_{B} is compared to identify the effectiveness of the publisher in Section 6.

In one embodiment, the squared error Σⱼ(Nⱼ−\hat{N}ⱼ)² is used as the criterion of the estimation, where Nⱼ denotes the actual number of conversions in IF-level j recorded by publishers and \hat{N}ⱼ; denotes the estimated number of conversions based on the estimated conversion rates \hat{q}ⱼ=\hat{q}_{B}+\hat{α}\hat{γ}^{j}:

(\hat{q}_{B},\hat{α},\hat{γ})=argmin_{q}_{_{B}}_{,α,γ}Σⱼ(Nⱼ−\hat{N}ⱼ)². (12)

For each case of (publisher, campaign), the actual impression delivery (reach) data rᵢ is used to compute \hat{N}ⱼ, according to one embodiment of the invention. Two methods to solve this optimization problem (12) are presented in Sections 5.1 and 5.2. A person skilled in the art can solve this problem (12) in a different way starting from embodiments of the invention.

5.1 Accurate Estimation of Conversion Rate

An accurate way to estimate q_{B}, α, and γ is to use the latent converting power model in Section 4.2 to compute \hat{N}ⱼ. This computation is complex (extremely as the duration of a campaign L increases) and nonlinear to qⱼ. It involves building the transition matrices Tᵢ [symbol] and [symbol] with replacing qⱼ with q_{B}+αγ^{j} and multiplying all the (2L+2)-by-(2L+2) transition matrices (as many as 2L). This is a time-consuming process and, even worse, needs to be done every time estimates are requested or needed according to one embodiment of the invention. Since this is not a regular form of estimation, there is not an efficient algorithm to estimate the parameters. The best result would be achieved by the brute-force algorithm, which also makes the estimation inefficient.

5.2 Approximation and Exponential Regression

In one embodiment, an approximate calculation of \hat{N}ⱼ; is used. This number can be approximated to \hat{q}ⱼ Σᵢ B_{i,j} when \hat{q}ⱼ≦≦1. In FIG. 8, the people in state [symbol] ⱼ move to state [symbol] ⱼ with a rate of qⱼ every day. From the analogy between the state [symbol] ⱼ and the set [symbol] _{i,j} of the model in FIG. 6, it is induced that the number of people in the state [symbol] ⱼ on Day i is approximately equal to B_{i,j}, the number of people in [symbol] _{i,j}. Thus, approximately qⱼ B_{i,j} people among B_{i,j} people move from [symbol] ⱼ to [symbol] ⱼ on Day i.

The approximation is specifically useful because it enables us to relate \hat{N}ⱼ; linearly to \hat{q}ⱼ. In one embodiment, computing B_{i,j} for 1≦i≦L and 1≦j≦i once is needed. Then the optimization problem (12) becomes

(\hat{q}_{B},\hat{α},\hat{γ})=argmin_{q}_{_{B}}_{,α,γj}(Nⱼ−qⱼΣᵢ₌₁^{L}B_{i,j})²=argmin_{q}_{_{B}}_{,α,γ}Σⱼ(Nⱼ−(q_{B}+αγ^{j})Σᵢ₌₁^{L}B_{i,j})². (13)

5.3 Audience Adjusted Assessment (AAA)

Moreover, the performance of publishers with all ingredients discussed so far is determined or computed. In one embodiment, the conversions may be classified into four groups as described below. A person skilled in the art may find another categorization of conversions from embodiments of the invention.

General Baseline Conversion:

This conversion is made irrelevantly of any advertising activity. This would be made even without the advertisements.

Replacing qⱼ by p_{B} in the latent converting power model in Section 4.3, the number of general baseline conversion may be estimated. If the actual number of conversions is smaller than the estimate, all conversions as the general baseline conversions may be classified. Otherwise, the difference will be classified as the other three types of conversion.

Target-Specific Baseline Conversion:

This conversion comes not from advertising effect but from audience targeting. This type of conversion is similar as the general baseline conversion in the sense that it would be made even without the advertisements. However, the difference arises by the fact that publishers may have targeted the audiences who are likely to convert. In this case, the baseline conversion rate of the target audiences q_{B} is higher than the general baseline conversion rate p_{B}.

The target-specific baseline conversion is the difference between them. q_{B} is estimated by the IF-level population model and the regression method and the number of baseline conversions by using the latent converting power model with replacing qⱼ by q_{B}. If the estimate is greater than the general baseline conversion, their difference becomes the target-specific baseline conversion. Otherwise, the target-specific baseline conversion is 0.

Causal Conversion:

This conversion is considered as the advertising effect. Unlike the first two types of conversion, this conversion would not be made without the advertisements. Therefore, the amount of causal conversions can indicate the effect of advertising of a publisher. This type of conversion is expressed as α in a conversion rate model according to one embodiment of the invention.

Potentially Fraudulent Conversion:

If conversion rate is too high compared to the baseline conversion rate of target audiences, it is suspected that there might be some fraudulent activities or malfunction of system either from users' end or from publishers' end that result in such a high conversion rate. As such, k×q_{B} is used as the maximum of the reasonable conversion rate (i.e., q_{B} of target-specific baseline conversion rate and (k−1)q_{B} of causal conversion rate); k is determined based on industry benchmarking. Any conversion exceeds the limit is considered as a potentially fraudulent conversion.

The AAA process gives estimates of the baseline conversion rate and causal conversion rate. In the next Section, it is determined which publisher is good at targeting and which publisher is effective based on the target-specific baseline conversion, causal conversion, and potentially fraudulent conversion.

6 Results and Discussion

6.1 Performance of Overall Campaigns

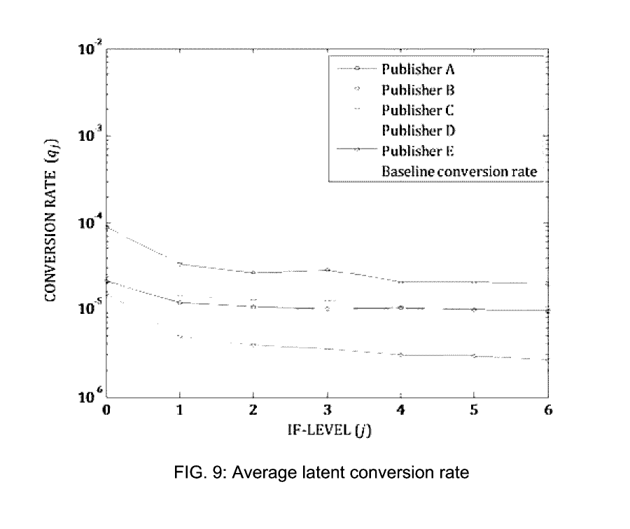

First, overall campaign results of each publisher are analyzed. FIG. 9 shows the empirical conversion probability of the publishers over all campaigns they participated. The conversion rate tends to decrease as IF-level increases. Specifically, the decrease from IF-level 0 to IF-level 1 is notable: the conversion rates commonly drop significantly from IF-level 0 to IF-level 1 and stay rather constant from IF-level 1. This observation can be explained by two reasons: First, audiences may easily forget display ads. Second, the publishers are good at targeting, which picks out audiences whom they can convert, and deliver more impressions to them.

FIG. 9 shows which publisher performs well. Publishers D and E outperform other publishers. They are followed by publishers A and C that are mediocre compared to the baseline. The conversion rate of publisher B is mostly below the baseline conversion rate. In other words, publisher B executed campaigns worse than random targeting and white blank ad.

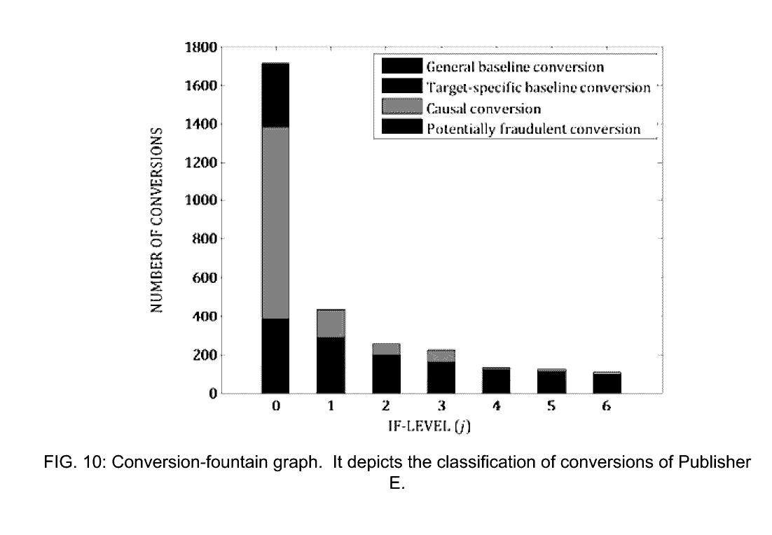

However, a high conversion rate is not always desired. A too high conversion rate may be a result of targeting people who will convert anyway. It is a nontrivial problem to determine the threshold of conversion rate to classify fairly good performance and potentially fraudulent performance. For example, FIG. 10 shows contribution of Publisher E explicitly. Conversions drawn in blue are irrelevant to the campaigns. They would have been made even if the campaigns did not happen (or even if the creatives are white blank). Conversions in green are irrelevant to the campaign as well but they show the additionally achieved conversions due to targeting. The green bars imply that Publisher E targeted people with a high likelihood of conversion and because of the targeting, it earned as many conversions as the green on top of the general baseline conversions (blue bars). Any conversions above the blue and green parts are due to the campaigns. Among them, conversions due to fair effect of the campaigns, which are called causal conversions, are marked in orange. The fair effect includes proper targeting of audiences and well-made creatives. Conversions other than baseline and causal conversions are doubtful because the number of conversions is unreasonably too large compared to advertising effect in common sense. They are depicted in red. According to one embodiment of the invention, most of the conversions made by publishers C, D, and E are doubtful ones. On the other hand, publisher C is futile in the sense that they don't even have many causal conversions.

6.2 Performance of Individual Campaigns

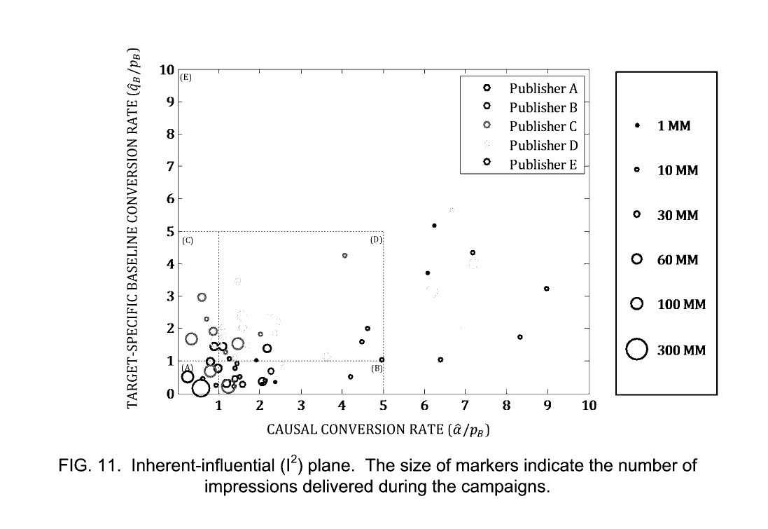

FIG. 11 visualizes the performances of publishers in a different way. Each campaign is marked in a two-dimensional space with respect to the corresponding conversion rates. Its y-axis represents the target-specific baseline conversion rate \hat{q}_{B}, which indicates the converting inherence of the targeted audiences. Its x-axis represents causal conversion rate \hat{α}, which indicates the converting influence of the advertisement campaigns. Thus, this graph is called inherent-influential plane. It is observed that these two values because the former represents the baseline conversion rate—the conversion rates when advertising effects have disappeared—and the latter represents the maximum conversion rates driven by advertising. The size of markers indicates how many impressions were delivered during the campaigns.

In one embodiment, FIG. 11 shows five classifications. First, the bottom-right rectangle (A) represents poor execution of a campaign. The baseline conversion rate of the audiences is even lower than the general baseline p_{B}. Moreover, the campaign did not boost the conversion rate above p_{B}. The campaigns in (A) failed both to select right audiences and to convert them. It is better to stop investment to publishers in (A). Second, the area (B) also represents a poor selection of audiences because \hat{q}_{B}<p_{B}. Unlike (A), however, campaigns in (B) successfully yielded conversions out of them. Thus it is worth maintaining the investment to publishers in (B), like Publisher B.

Third, the area (C) implies good targeting but not much causality of the sales; most of the conversions seem like the baseline conversions of the selected audiences. Thus, an advisable action for the campaigns in (C) is first to investigate them deeper in order to find the reasons why advertising was not effective and then to take a proper follow-up action. Some examples of the reasons are a bad placement of ads, lame creatives used in the campaign, or fraud attempts made in the campaign. Fourth, the area (D) represents good targeting and effective audience conversion. Since publishers in (D), like Publisher D, execute campaigns well, it is better to increase investment to these publishers. Lastly, (E), the outside region of the previous four regions, represents unreasonably high conversion rates. Campaigns classified to (E) are likely to (re)target people who will convert regardless. Thus, in one embodiment, it is suggested to scrutinize the publishers in (E), such as Publisher E. It is remarkable that the publishers are distinguishable with respect to the causality in FIG. 11 while publishers A and C and publishers D and E seem to achieve similar conversion rates in FIG. 9.

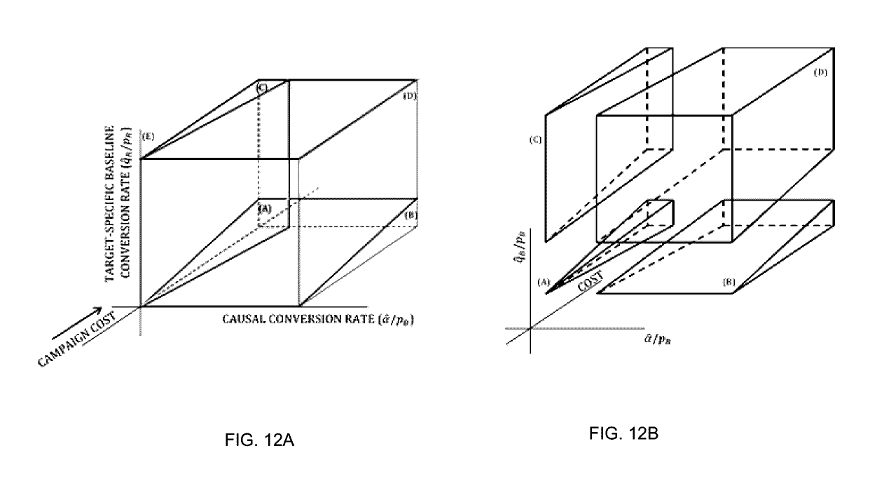

According to one embodiment of the invention, other KPIs may be taken into account. In another embodiment, FIGS. 12A and 12B illustrates two diagrams showing three dimensional classification space, where the classification rule depends on the campaign cost as well as the target-specific baseline conversion rate and the causal conversion rate. A campaign with a small cost does not have to be assessed as strictly as a campaign with a much higher cost should be. FIG. 12 shows more relaxed rule of category (D) for inexpensive campaigns.

This investment discusses intuitions of the impression-conversion relationship in online display advertising campaigns and analyzes the conversion rate in terms of when audiences have seen their last impressions. While delivering impressions to audiences, publishers may acquire conversions from those who are not likely to convert and, by a lucky chance, from those who would convert regardless of the impressions. The former has strong causality to advertising but the latter has very weak or no causality. Every conversion is equally valuable to publishers with respect to their compensations. To advertisers, however, conversions of the former is more valuable than conversions of the latter. Even though current pricing models do not take into account the causality of conversions, advertisers can indirectly reward or penalize publishers by increasing or decreasing their investments. Thus, true contribution of publishers is assessed in this investment to help such decision making.

The time-decaying phenomenon of advertising effect is one of the most important insights identified from the data according to one embodiment of the invention. When comparing a group of audiences who received impressions today and another group who received ones not today but yesterday, data from one embodiment of the invention clearly revealed that the conversion rate of the former group is higher than that of the latter. The effect of advertising becomes weaker as time passes, so does the causality between conversions and advertising. Eventually, conversions made after a significant amount of time are hardly caused by advertising: according to one embodiment of the invention, it is considered as baseline conversions which publishers should not take credit for.

From aspects of the invention, one may further estimate the baseline conversion rate and the causal conversion rate. For this example, an audience model may be built to group people in terms of their IF-level and use exponential regression method. One advertiser and five publishers have been chosen for the demonstration. In the demonstration, the method from one embodiment of the invention may distinguish publishers with high causality and low causality even though their overall conversion rates are similar. Finally, aspects of the invention have proposed classification criteria and proper investing decision making for each class of publishers.

Moreover, it is to be understood that embodiments of the invention may be utilized to analyze effectiveness of marketing activity with respect to other agents than publishers. For example, it is important to understand the effectiveness of marketing activity depending on customer group(s). The group can be determined with respect to several factors such as age, gender, address, and income level. Using the same method except classification (not of publisher but) of customer groups of a particular concern or interest, one may discover which customer group the marketing activity is most effective. This discovery is beneficial to marketing decisions that can maximize the benefit of advertising.

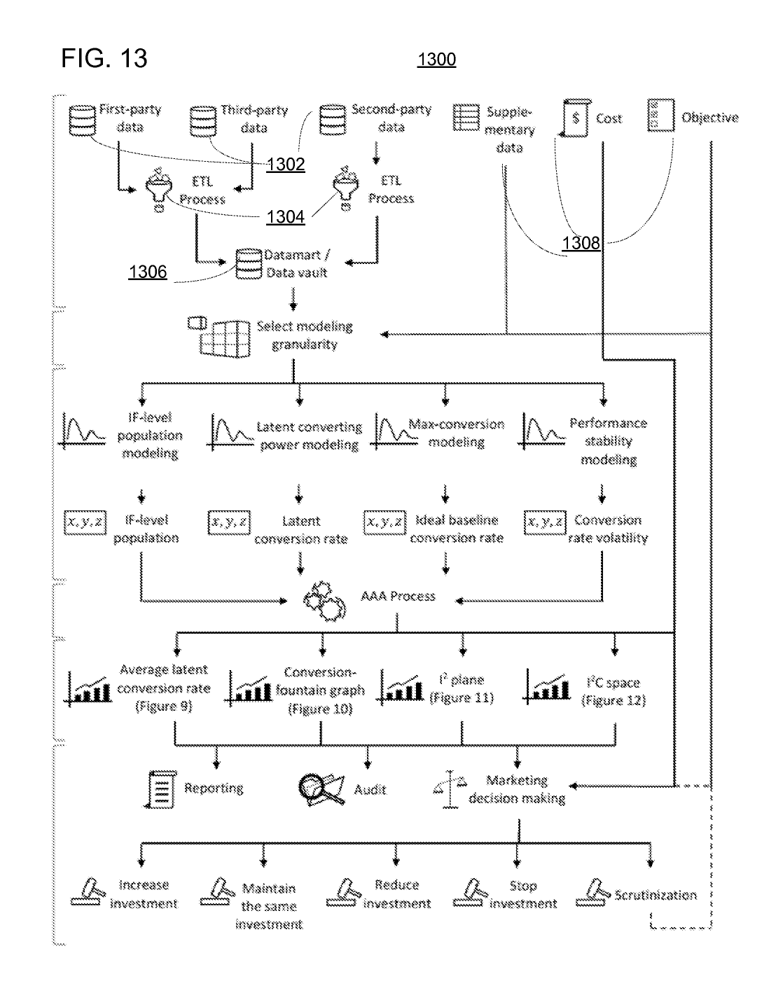

In operation, FIG. 13 illustrates an exemplary diagram showing a system 1300 for determining effectiveness of a publisher according to one embodiment of the invention. In one embodiment, the system 1300 includes a computing network or computing execution environment. For example, the computing network includes a plurality of computing devices performing a number of distributed network functions. In one example, a set of computing devices may be used as servers providing requests from a set of computing devices that send requests, such as client devices. In a further example, a set of computing devices may serve as database servers or database devices providing the data storage for the servers. It is to be understood that these devices may be mainframe computers or standalone computers that are clustered together through computer networks such that interconnectivity of the computing devices as well as distributed processing by the computing devices may be achieved. It is also to be understood that functions and operations described above and below may be performed by any set of computing devices.

In one example, the system 1300 includes a plurality of raw data input from a number of data sources 1302. For example, as shown in FIG. 13 for illustration purposes, the data sources or datasets 1302 may come from a first-party data, a second-party data and a third-party data. It is to be understood that data from other sources may be added without departing from the scope and spirit of the invention. In one example, the data sources 1302 may be provided for process according to examples illustrated in FIGS. 2-12 via file transfers through file transfer protocol (FTP) or text file transfers. In another embodiment, each of the data sources 1302 may be independent from one another. In addition, the raw data from the data sources 1302 may be supplied to the system 1300 or the system 1300 receives the raw data from the data sources 1302 in a continuous manner. For example, the raw data may be provided to the system 1300 in a periodic fashion or an ad hoc fashion.

Once the data is collected or mined from the data sources 1302, the system 1300 proceeds to an extract-transform-load (ETL) process 1304. In one embodiment, the ETL process 1304 includes at least one of the following functions: extract, transform and load. For example, upon receiving the data from the data sources 1302, the system 1300 extracts the relevant data from the received data. As an illustration, suppose the first-party data includes data from Data provider A, the second-party data includes data from Data provider B, and the third-party data include data from Data provider C. Data provider A stores and transmits its data according to ASCII format text in a text file with a file size not exceeding 5 MB, as an example. Data provider A also uses “;” as a field delimiter. Data provider B, on the other hand, stores its data in zip file format with spreadsheet information therein. Data provider C also stores its data in a text file but use “::” as a field delimiter.

As such, upon receiving the data from these three data providers, the system 1300 first extracts the different sets of data with different formatting specification. During extraction, the system 1300 determines the data set and normalize all data such that the data is ready for processing in the next stage: transformation.

During the transformation, the extracted data is transformed to convert the “raw data” to “relevant data.” For example, suppose all data from the Data provider A, Data provider B, and Data provider C include information such as: number of advertisers; number of keywords/key terms purchased by the advertisers; rate of the publisher per term; and a duration of each advertisers for running the keywords/key terms. During transformation, in this example, the system 1300 would transform all data to properly fit into each category such that they could be easily consumed and loaded for further process and analysis—in accordance with the one or more functions/features described above. At the same time, the system 1300 further identifies relevant and irrelevant data during the transformation process. Once the transformation is completed, the data is read to be loaded for processing and it is stored in a data mart or data vault 1306 for further processing.

Still referring to FIG. 13, the data vault 1306 further may receive data from a user attribute source 1308. In one example, the user attribute source 1308 may include data such as supplementary data, cost data, and objective data. In one example, the supplementary data may include survey data for understanding customer behavior or for defining customer behavior. It is to be understood that other data from the user attribute source 1308 may be included without departing from the scope or spirit of the invention.

As such, during the transformation as well as the subsequent input data from the user attribute source 1308, embodiments of the invention provide a rich and robust dataset of a grouping of marketing activities that may be derived from the Data provider A, the Data Provider B, the Data Provider C, and the user attribute source. The transformation may also be able to include data that may not come from a particular data provider, such as Data provider A, but may be deductible by overlapping the plurality of data from these different data providers.

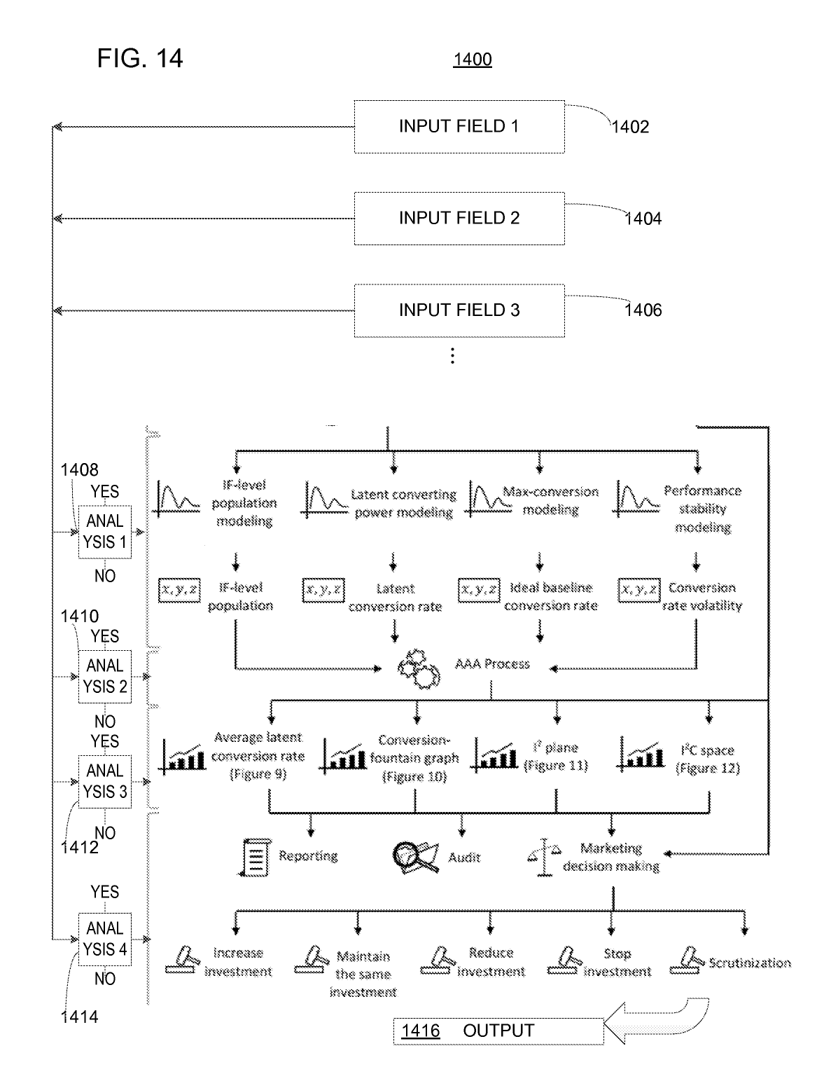

For further illustration of the system 1300, the user attribute source 1308 may be supplied as inputs for the system 1300 to perform the analysis. Referring to FIG. 14, an exemplary graphical user interface 1400 for receiving input from a user for determining the efficiency of a publisher according to one embodiment of the invention. For example, the graphical user interface (GUI) 1400 may be presented, provided, or rendered to a user (not shown) on one or more client devices, such as a display on a computing device. For example, the computing device may include a desktop, a laptop, a tablet, a smartphone, a cellular phone, a watch, a smart watch, or a wearable electronic device. The user may interact with the GUI 1400 via a number of ways, such as via voice commands, touch, motion, pressure from a touch, gestures from a touch, and a combination of the above inputs. It is to be understood that sensors for sensing these command-issuing ways may be incorporated within the computing device or in connection with the computing device, but that is not the focus of the present invention.

The user, for example, may be an advertiser who wishes to determine which publishers is the most efficient for its objective. For example, the user may enter in an input field 1 1402 information such as cost. In this example, the cost information may be related to the amount of the money the advertiser wishes to spend for a given advertisement campaign. As such, the input field may accept values such as numerical values and may be converted to a uniform currency unit, such as US dollar. The user may further enter addition information to an input field 1404, which may include supplemental data. For example, the supplemental data may include survey data about likelihood of the purchasing behavior of smartphones for male subjects ages between 18-25 after the smartphones have been released for more than 6 months. In another embodiment, the user may provide input data in an input field 3 1406 that includes the user's objective information. For example, the objective information may be expressed in a particular syntax or set of strings or text that may be interpreted by the system 1300 or may be coded by an analyst who reviews the accuracy of the input fields 1402, 1404, and 1406. It is to be understood that other input fields may be available or added without departing from the scope or spirit of the invention.

Once the input from the input fields 1402, 1404, and 1406 are received, the inputs are fed for the different analyses described above. For example, 1408 is for Analysis 1, 1410 is for Analysis 2, 1412 is for Analysis 3, and 1414 is for Analysis 4. These analyses capabilities or availabilities may be selected by the user for the system 1300 to process. Lastly, the system 1300 provides an output 1416 to the user indicating the outcome of the analysis.

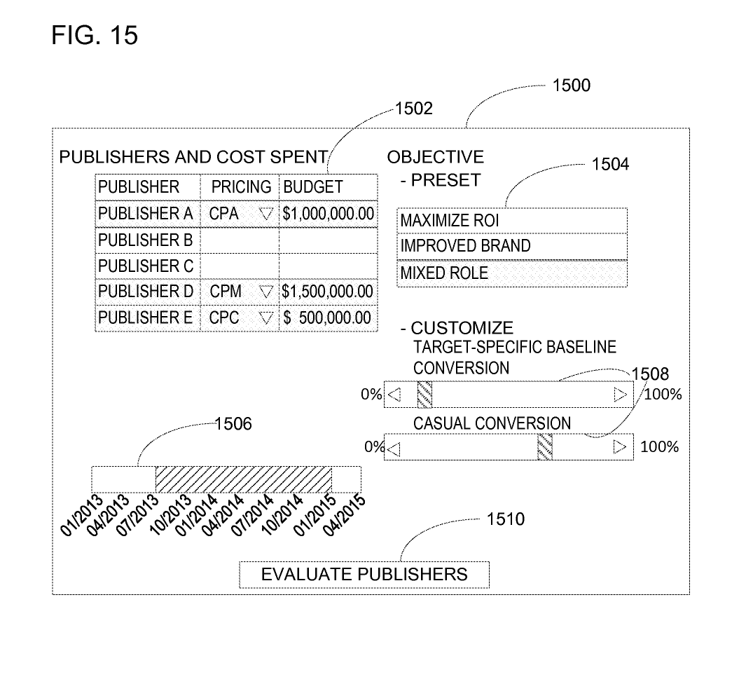

In another example, FIG. 15 illustrates another example of an input graphical user interface according to one embodiment of the invention. In this embodiment, a graphical user interface 1500 includes one or more fields for setting parameters for a user to configure as inputs. Further, the GUI 1500 may be incorporated into a client application on a laptop or a desktop or an app installed on a client device (mobile or otherwise), or a web-interface available on a cross-platform network. For example, the user may first select one or more publishers in the first input field 1502. It is to be understood that the list of publishers may be provided based on a list or a partial list of publishers that the user may receive evaluation. Also, it is to be understood that other customer group may be part of the input in 1502 instead of publishers, as previously described. In this example as illustrated in FIG. 15, “Publisher A,” “Publisher D,” and “Publisher E,” have been selected (as depicted via the shaded lines) for the selection in the first input field 1502.

The user may further select a number of ways to provide their objectives. In one example, as illustrated in the example in FIG. 15, a set of two input is available to the user to provide the objectives. It is to be understood that other numbers of input or other forms of input (pictorial, diagram-orientated, etc.) may be provided without departing from the scope or spirit of the invention.

In this example, the user may set objectives by clicking one of pre-set objectives in a second input field 1504 or by customizing the percentages of conversion categories in third input fields 1508. For example, the pre-set objective, which automatically adjusts the percentages of conversion categories in 1508, may include one or more of the following: Maximize ROI, Improve Brand, Mixed Role, etc. It is to be understood that other objectives or other freeform entries in the objectives may be entered without departing from the scope or spirit of the invention. In this example, the “Mixed Role,” is selected in the second input field 1504 (as depicted via the shaded lines). In addition, the third input field 1508 allows the user to customize objectives in more detail. For example, a set of customization third input fields 1508 may include inputting a percentage value of a target-specific baseline conversion (TSBC) or a percentage of a causal conversion (CC). In one example, the target-specific baseline conversion or the causal conversion may initially be preset or predetermined by developers or users. Alternatively, the user would provide or enter the percentages of TSBC and CC in 1508 by themselves by moving the slide bars. Further, a third field 1506 for setting a time or date range may be available to the user.

Once the input parameters in the fields 1502, 1504, 1506 and 1508 are set, the user may select an action or execute button 1510 (that is “evaluate publishers”) to activate or trigger the evaluation of the publisher or the customer group.

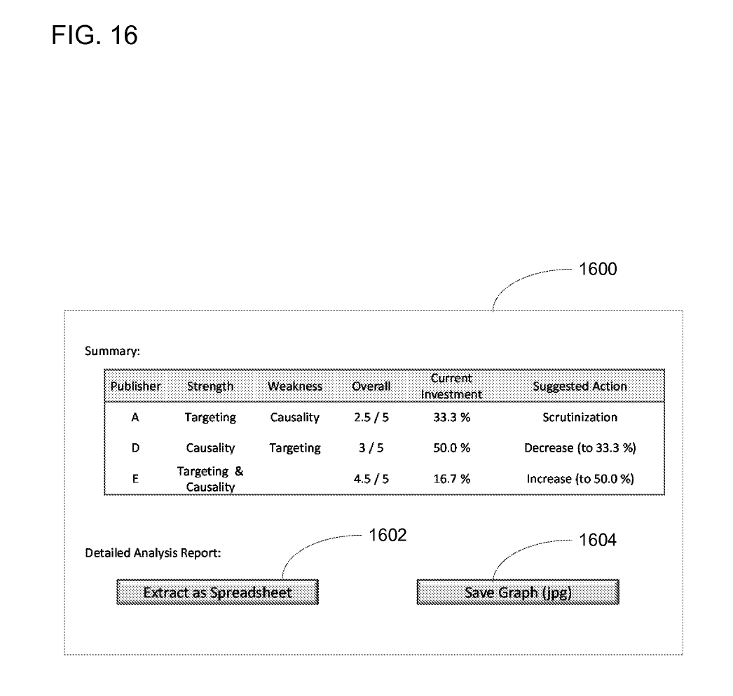

Referring now to FIG. 16, an exemplary output graphical user interface is illustrated according to one embodiment of the invention. In this example, an output graphical user interface 1600 may present the output, based on, for example, inputs provided from the user through the input GUI 1500. Further, the GUI 1600 may be incorporated into a client application or an app installed on a client device (mobile or otherwise), or a web-interface available on a cross-platform network. In this example, the output GUI 1600 is rendered or provided in a table format. It is to be understood that other formats may be provided without departing from the scope or spirit of the invention. In one example, the output GUI 1600 may further include additional report options, such as a spreadsheet output 1602 and a graph output 1604. It is to be understood that other output options may be available without departing from the scope or spirit of the invention. Moreover, the output GUI 1600 shows exemplary output data. For example, as previously indicated in FIG. 15, Publisher A, Publisher D and Publisher E have been selected in the first input field 1502. As such, FIG. 16 illustrates the output GUI showing the analysis, after the user has selected the “evaluate publishers.” It is to be understood that output may include additional data or additional fields without departing from the scope or spirit of the invention. In one example, the output GUI may include the user input such that the user may be reminded of the input so as to refer to the input more easily. In another example, the output GUI may include more graphical elements, such as dashboard dials to show percentage as well as different colors showing degree of “strength” or “weakness” in the output GUI. In a further embodiment, the identification of the publisher or customer group may be replaced by the logo of the publisher or customer group.

Moreover, 1. A system and method for marketing activities reporting, audit, and decision making by analyzing a plurality of metrics such as publishers' performance, delivered impressions, clicks, and conversions both within and outside the duration of the marketing activities either independently or jointly with other publishers and advertisers.

2. Whereas performance in 1 may be measured in a plurality of metrics such as retargeting performance, population behavioral targeting performance, population demographic targeting performance, audience mean quality, audience convergence probability distribution function, target-specific baseline conversion probability, causal conversion probability, and conversion rate volatility

3. Whereas publishers in 1 may refer to online display publishers, ad servers, search advertisements, online video publishers, digital TV, digital radio, or any other marketing-message delivering entities.

4. Whereas marketing activities in 1 may include a campaign, a plurality of campaigns for a particular advertiser or a plurality of advertisers within an industry vertical, or all campaigns served by the publishers.

5. Whereas the delivered impressions, clicks, and conversions in 1 may be analyzed on the event-by-event basis, on an hourly aggregated basis, on a daily aggregated basis, or on any other level of granularity.

6. Whereas the aggregation in 5 may refer to aggregation by publisher, campaign, date of event, number of days since last event, type of conversion, or any other category available through the plurality of log data according to one embodiment of the invention.

7. Whereas the aggregation in 5 may refer to aggregation by categories that are not available in the log data but can be deduced by overlapping the log data with other first-party, second-party, or third-party datasets.

8. Whereas performance in 1 may be measured by assessing individual publishers' contributions or by considering publisher group contribution.

9. Whereas publisher group in 8 may refer to a group of two or more publishers.

10. Whereas performance in 1 may be reported in a series of scalar values along predetermined dimensions or in a categorical way as compared to a plurality of benchmark performances.

11. Whereas in one embodiment, benchmark performances in 10 may include profitability, effectiveness, and stability.

12. Whereas in one embodiment, performance in 1 is dependent on a plurality of short-term, mid-term, and long-term effect of marketing as discovered by the Impression Fadeaway Level (IF-level) modeling and the Latent Converting Power modeling.

13. Whereas in another embodiment, performance in claim 1 is dependent on the parameters of a varying-complexity targeting factor recovery model and is estimated using event-level or aggregated data discussed in 5, 6, and 7.

14. Whereas the effect of marketing in 12 is processed by Audience Adjusted Assessment (AAA) process to evaluate the benchmark performances discussed in 10 and 11.

15. Whereas the performance in 1 may be measured by categorization of conversion events into a plurality of conversions according to probability of causality along a plurality of categories and depicted as Conversion-fountain graph and Inherent-Influential (I2) plane graph.

16. Whereas the categorization in 15 may be dependent on the cost of the marketing activities and depicted as Inherent-Influential and Cost (I2C) space graph.

17. Whereas the performance in 1 can be reported both in absolute terms as well as relative to other publishers independent of them participating or not participating in the particular marketing activity of interest.

18. A system and method where performance calculated in 1 is used for publisher remuneration decision making or advertising purchase decision making in marketing activities.

19. Whereas the reporting, audit, and decision making in 1 may refer to stopping investment, maintaining the same investment after due diligence, increasing investment, and investigating and scrutinizing further about fraud, visibility, and creative quality, among other things.

At least one aspect of the invention is to evaluate campaign results in a multifaceted manner for helping advertising investment decision making. The system and method invented first measures audience population of a campaign lasting for a predetermined period. Then it estimates converting power of the campaign and decomposes it into multiple factors: chiefly baseline conversions due to inherit properties of the selected (targeted) audiences and causal conversions truly due to advertising effect. These factors are compared to several criteria to classify the efficiency and effectiveness for a campaign, for a publisher or in any other cut.

What is claimed is:

1. A computerized method for determining effectiveness of a marketing activity comprising:
obtaining a plurality of marketing activity data of the marketing activity;
determining a segmentation logic of interest to group the plurality of marketing activity data;
determining a baseline conversion rate based on the determined segmentation logic;
recording a conversion rate in response to the marketing activity;
identifying a decay factor based on the recorded conversion rate and the obtained plurality of marketing activity data;
calculating a conversion probability as a function of at least one or more of the following: number of days of the marketing activity, the conversion rate, and the decay factor; and
determining the effectiveness of each group of marketing activities based on the calculated conversion probability.

2. The computerized method of claim 1, wherein determining the segmentation logic comprises determining the segmentation logic including at least one of grouping by publisher, by creative, by campaign, by date, by audience demographic group, by audience behavioral group, by number of days since a given event, by number of conversions or by any other category available in the plurality of the available data.

3. The computerized method of claim 1, wherein determining the segmentation logic of interest comprises determining the segmentation logic of interest to group the marketing activities by grouping categories that are not available in the data but deducible by overlapping the plurality of data with other first-party, second-party, third-party or fourth-party datasets.

4. The computerized method of claim 1, wherein obtaining the plurality of advertising campaign data comprising obtaining at least one of the following: performance of the marketing group, delivered impressions of the marketing activity, clicks of the marketing activity, and conversions both within and outside the duration of the marketing activity either independently or jointly with other publishers and advertisers.

5. The computerized method of claim 4, wherein the performance of the marketing group comprises data in at least one of the following factors: retargeting performance, population behavioral targeting performance, population demographic targeting performance, audience mean quality, audience convergence probability distribution function, target-specific baseline conversion probability, causal conversion probability, and conversion rate volatility.

6. The computerized method of claim 2, wherein the grouping by publisher comprises publishers from at least one of the following: online display publishers, advertising servers, search advertisements, online video publishers, TV, radio, or any other marketing-message delivering entities.

7. The computerized method of claim 1, wherein the marketing activity comprises at least one of the following: an advertising campaign, a plurality of campaigns for a particular advertiser or a plurality of advertisers within an industry vertical, or all campaigns served by the publishers.

8. The computerized method of claim 5, further comprising analyzing the performance of the group of marketing activities on an event-by-event basis, on an hourly aggregated basis, on a daily aggregated basis, or on any other level of granularity.

9. The computerized method of claim 1, wherein identifying the decay factor comprises identifying the decay factor based on a plurality of short-term, mid-term, and long-term effect of marketing as discovered by the Impression Fadeaway Level (IF-level) modeling and the Latent Converting Power modeling.

10. The computerized method of claim 1, wherein determining the effectiveness comprises determining a benchmark performance by employing Audience Adjusted Assessment (AAA) process to evaluate the calculated conversion probability.

11. The computerized method of claim 1, wherein determining the effectiveness comprises measuring the effectiveness by categorization of conversion events into a plurality of conversions according to probability of causality along a plurality of categories and depicted as Conversion-fountain graph and Inherent-Influential (I²) plane graph.

12. The computerized method of claim 11, further comprising adjusting the effectiveness as Inherent-Influential and Cost (I²C) space graph based on cost of the marketing activities.

13. The computerized method of claim 1, further comprising providing effectiveness in at least one of the following way: a series of scalar values along predetermined dimensions or in a categorical way with respect to a plurality of benchmark performances, including profitability and stability.

14. The computerized method of claim 13, wherein providing comprises providing the plurality of benchmark performances both in absolute terms as well as relative to other subgroups of marketing activities independent of them being part of or not part of the particular marketing activity in the campaign of interest.

15. A system configured for determining an effectiveness value of a marketing activity comprising:
a plurality of data stores storing a plurality of marketing activity data of the marketing activity;
an interface interconnecting between the plurality of data stores and a processor;
said processor being configured to execute computer executable instructions, said computer executable instructions comprising:
obtaining the plurality of marketing activity data from the plurality of data stores through the interface;
executing a segmentation logic of interest to group the plurality of marketing activity data;
determining a baseline conversion rate based on the grouped plurality of marketing activity data in response to the executed segmentation logic;
generating a conversion rate in response to the marketing activity;
identifying a decay factor based on the generated conversion rate and the obtained plurality of marketing activity data;
calculating a conversion probability as a function of at least one or more of the following: number of days of the marketing activity, the conversion rate, and the decay factor; and
providing the effectiveness value of the grouped plurality of marketing activity data based on the calculated conversion probability.

16. The system of claim 15, wherein the processor is further configured to execute computer executable instructions for selecting another segmentation logic of interest, wherein the processor is configured to execute the another segmentation logic of interest to group the plurality of marketing activity data in response to the providing.

17. The system of claim 15, wherein the processor is further configured to execute computer executable instructions for providing the effective value to a user for evaluating at least one of remuneration factors: advertising purchase decision making in specific group of marketing activities, stopping investment in a specific group of marketing activities, maintaining the same investment after due diligence in a specific group of marketing activities, increasing investment in a specific group of marketing activities, and investigating and scrutinizing further in a specific group of marketing activities.

18. A computerized method for determining effectiveness of a marketing activity comprising:
determining a segmentation logic of interest to group a plurality of marketing activity data obtained from a plurality of data sources;
determining a baseline conversion rate based on the determined segmentation logic;
recording a conversion rate by users in response to the marketing activity;
identifying a decay factor based on the recorded conversion rate and the obtained plurality of marketing activity data;
calculating a conversion probability as a function of at least one or more of the following: number of days of the marketing activity, the conversion rate, and the decay factor; and
determining the effectiveness of each group of marketing activities based on the calculated conversion probability.

19. The computerized method of claim 18, wherein determining the segmentation logic of interest comprises determining the segmentation logic of interest to group the marketing activities by grouping categories that are not available in the data but deducible by overlapping the plurality of data with other first-party, second-party, third-party or fourth-party datasets.

20. The computerized method of claim 18, wherein identifying the decay factor comprises identifying the decay factor based on a plurality of short-term, mid-term, and long-term effect of marketing as discovered by the Impression Fadeaway Level (IF-level) modeling and the Latent Converting Power modeling.
